(19) United States
(12) Patent Application Publication
(10) Pub. No.: US 2025/0132114 A1
(43) Pub. Date: Apr. 24, 2025

(54) ELECTROMAGNETIC RELAY

(71) Applicant: OMRON Corporation, Kyoto-shi (JP)

(72) Inventors: Masaki SUGIHARA, Kyoto-shi (JP); Hiroyuki OTSUKA, Kyoto-shi (JP); Masayuki NODA, Kyoto-shi (JP)

(21) Appl. No.: 18/902,962

(22) Filed: Oct. 1, 2024

(30) Foreign Application Priority Data
Oct. 18, 2023 (JP) 2023-179438

(51) Int. Cl. H01H 50/14; H01H 50/04; H01H 50/44

(52) U.S. Cl. CPC H01H 50/14; H01H 50/045; H01H 50/443

(57) ABSTRACT

An electromagnetic relay includes a base, a seat, a first contact terminal, and a second contact terminal. The seat is a separate body from the base and is disposed below the base. The seat includes a first hole and a second hole. The first hole and the second hole each extend in the vertical direction. The first contact terminal extends downwardly from the base through the first hole. The first contact terminal includes a first bent portion bent along the bottom surface of the seat. The second contact terminal extends downwardly from the base through the second hole. The second contact terminal includes a second bent portion bent along the bottom surface of the seat.

### FIELD

The claimed invention relates to an electromagnetic relay.

### BACKGROUND

Among the electromagnetic relays, there is a so-called surface mount type. For example, as disclosed in Japan patent application publication No. 2016-201306, in a surface mount-type electromagnetic relay, a terminal protrudes downward from a base and has a bent portion that is bent laterally. The bent portion is soldered to a circuit board, thereby mounting the electromagnetic relay on the circuit board.

One method for mounting an electromagnetic relay on a circuit board is reflow soldering. In reflow soldering, solder is applied to the circuit board, and the electromagnetic relay is then placed on the solder. The solder is then heated in a reflow furnace, thereby soldering the electromagnetic relay to the circuit board. By using such reflow soldering, the electromagnetic relay can be efficiently mounted on the circuit board.

However, in the above-mentioned surface mount-type electromagnetic relay, depending on the arrangement of the terminals, the balance when placed on the circuit board may be poor, making it difficult to mount it on the circuit board. For example, if the terminals are arranged asymmetrically on the bottom surface of the base, the electromagnetic relay may not be able to maintain its posture when placed on a circuit board and may tilt. In that case, mounting by reflow soldering as described above is difficult. Alternatively, the electromagnetic relay may be placed unstably, which may reduce the accuracy of its mounting on the circuit board.

### SUMMARY

An object of the claimed invention is to provide an electromagnetic relay that can be stably mounted on a circuit board regardless of the arrangement of the terminals.

An embodiment of an electromagnetic relay in accordance with the claimed invention includes a base, a seat, a first contact terminal, and a second contact terminal. The seat is a separate body from the base and is disposed below the base. The base includes a first hole and a second hole. The first hole and the second hole each extend in the vertical direction. The first contact terminal extends downwardly from the base through the first hole. The first contact terminal includes a first bent portion bent along the bottom surface of the seat. The second contact terminal extends downwardly from the base through the second hole. The second contact terminal includes a second bent portion bent along the bottom surface of the seat.

In the embodiment of the electromagnetic relay, the seat prevents the electromagnetic relay from tilting when placed on a circuit board. Therefore, the posture of the electromagnetic relay before soldering can be stably maintained on the circuit board. This allows the electromagnetic relay to be stably mounted on the circuit board.

The seat may include a first groove and a second groove. The first groove may be provided on a bottom surface of the seat, and the first bent portion may be disposed therein. The second groove may be provided on the bottom surface of the seat, and the second bent portion may be disposed therein. In this case, the bottom surface of the seat is positioned closer to the circuit board. This makes it possible to maintain the posture of the electromagnetic relay on the circuit board more stable.

The first bent portion and the second bent portion may be disposed asymmetrically on the bottom surface of the seat. In this way, even if the terminals are arranged in a way that makes the electromagnetic relay unstable, the position of the electromagnetic relay on the circuit board can be kept stable by the seat.

The first bent portion and the second bent portion may be disposed on the bottom surface of the seat on a first side of a center line of the bottom surface of the seat. In this way, even if the terminals are arranged in a way that makes the electromagnetic relay unstable, the posture of the electromagnetic relay on the circuit board can be kept stable by the seat.

The seat may include a third hole and a fourth hole. The third hole and the fourth hole may extend in the vertical direction. The electromagnetic relay may further include a first coil terminal and a second coil terminal. The first coil terminal may extend downwardly through the third hole. The first coil terminal may include a third bent portion bent along the bottom surface of the seat. The second coil terminal may extend downwardly through the fourth hole. The second coil terminal may include a fourth bent portion bent along the bottom surface of the seat.

The first bent portion, the second bent portion, the third bent portion, and the fourth bent portion may be disposed on the bottom surface of the seat on the first side of the center line of the bottom surface of the seat. In this way, even if the terminals are arranged in a way that makes the electromagnetic relay unstable, the posture of the electromagnetic relay on the circuit board can be kept stable by the seat.

The electromagnetic relay may further include an auxiliary terminal. The auxiliary terminal may be disposed on the bottom surface of the seat on a second side opposite to the first side with respect to the center line of the bottom surface of the seat. In this case, the auxiliary terminal can keep the electromagnetic relay in a more stable posture on the circuit board. Furthermore, by soldering the auxiliary terminal to the circuit board, the bonding strength of the electromagnetic relay to the circuit board is improved.

The bottom surface of the seat may include a first area, a second area, a third area, and a fourth area. The second area may be disposed symmetrically to the first area with respect to a first center line extending in the longitudinal direction of the bottom surface. The third area may be disposed symmetrically to the first area with respect to a second centerline that is perpendicular to the first centerline. The fourth area may be disposed symmetrically to the second area with respect to the second centerline. The first bent portion may be disposed in the first area. The second bent portion may be disposed in the first area or the third area. The third bent portion may be disposed in the third area. The fourth bent portion may be disposed in the fourth area. In this way, even if the terminals are arranged in a way that makes the electromagnetic relay unstable, the posture of the electromagnetic relay on the circuit board can be kept stable by the seat.

The electromagnetic relay may further include at least one auxiliary terminal. At least one auxiliary terminal may be arranged on the bottom surface of the seat in one of the first to fourth areas in which the first to fourth bent portions are not arranged. In this case, the auxiliary terminal can keep the electromagnetic relay in a more stable posture on the circuit board. Furthermore, by soldering the auxiliary terminal to the circuit board, the bonding strength of the electromagnetic relay to the circuit board is improved.

The electromagnetic relay may further include an auxiliary terminal provided on at least one of the first to fourth bent portions. In this case, the auxiliary terminal is soldered to the circuit board, thereby improving the bonding strength of the electromagnetic relay to the circuit board.

The seat may include a third groove and a fourth groove. The third groove may be provided on the bottom surface of the seat. The third bent portion may be disposed in the third groove. The fourth groove may be provided on the bottom surface of the seat. The fourth bent portion may be disposed in the fourth groove. In this case, the bottom surface of the seat is positioned closer to the circuit board. This makes it possible to maintain the posture of the electromagnetic relay on the circuit board more stable.

The seat may include a bottom plate and a side wall. The bottom plate may include the bottom surface of the seat. The side wall may extend upwardly from the bottom plate. The side wall may be disposed about the base. In this case, the movement of the base is restricted by the side wall of the seat. This improves the vibration resistance of the electromagnetic relay.

The side wall may include a recess that is downwardly recessed. In this case, the seat can be easily attached to and detached from the base. The side wall may include a first side wall, a second side wall, a third side wall, and a fourth side wall. The first side wall may be disposed on a left side of the base. The second side wall may be disposed on a right side of the base. The third side wall may be disposed forward of the base. The fourth side wall may be disposed rearward of the base.

An another embodiment of an electromagnetic relay in accordance with the claimed invention includes a base, a seat, a first coil terminal, and a second coil terminal. The seat is a separate body from the base and is disposed below the base. The seat includes a third hole and a fourth hole. The third hole and the fourth hole each extend in the vertical direction. The first coil terminal extends downwardly from the base through the third hole. The first coil terminal includes a third bent portion bent along the bottom surface of the seat. The second coil terminal extends downwardly from the base through the fourth hole. The second coil terminal includes a fourth bent portion bent along the bottom surface of the seat.

In the electromagnetic relay in accordance with this embodiment, the seat prevents the electromagnetic relay from tilting when placed on a circuit board. Therefore, the posture of the electromagnetic relay before soldering can be stably maintained on the circuit board. This allows the electromagnetic relay to be stably mounted on the circuit board.

### BRIEF DESCRIPTION OF THE DRAWINGS

FIG. 1 is a perspective view of an embodiment of an electromagnetic relay in accordance with the claimed invention.

FIG. 2 is a perspective view of the electromagnetic relay from below.

FIG. 3 is a bottom view of the electromagnetic relay.

FIG. 4 is an exploded perspective view of the electromagnetic relay.

FIG. 5 is a side view of a relay body with the case omitted.

FIG. 6 is a side view of the relay body with the case omitted.

FIG. 7 is a bottom view of the relay body.

FIG. 8 is a partial cross-sectional view taken along line VIII-VIII in FIG. 3.

FIG. 9 is a partial cross-sectional view taken along line IX-IX in FIG. 3.

FIG. 10 is a top view of a seat.

FIG. 11 is a bottom view of the seat.

FIG. 12 is a bottom view of an electromagnetic relay of a first modified embodiment.

FIG. 13 is a bottom view of an electromagnetic relay of a second modified embodiment.

FIG. 14 is a bottom view of an electromagnetic relay of a third modified embodiment.

FIG. 15 is a bottom view of an electromagnetic relay of a fourth modified embodiment.

FIG. 16 is a perspective view of an electromagnetic relay of a fifth modified embodiment.

FIG. 17 is a perspective view of an electromagnetic relay of a sixth modified embodiment.

### DETAILED DESCRIPTION

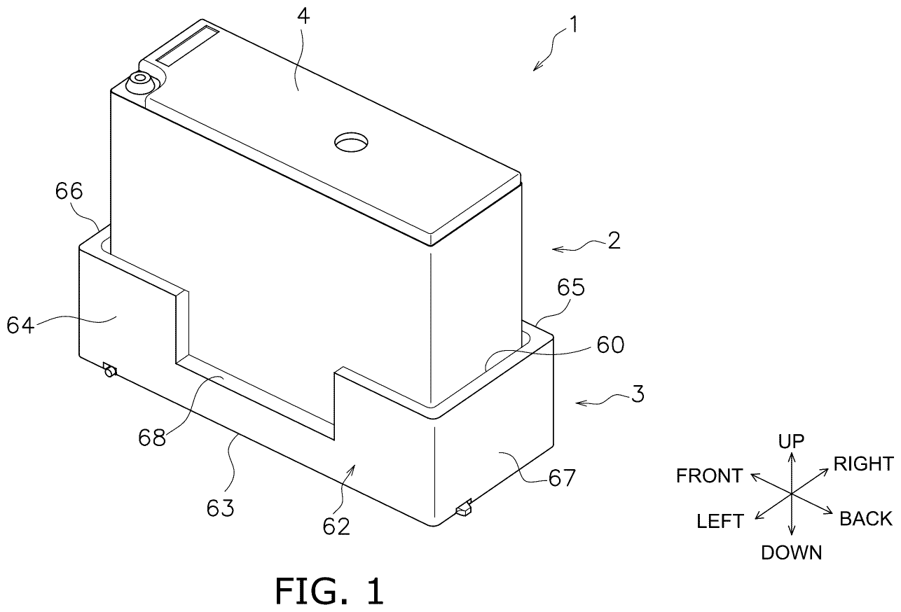

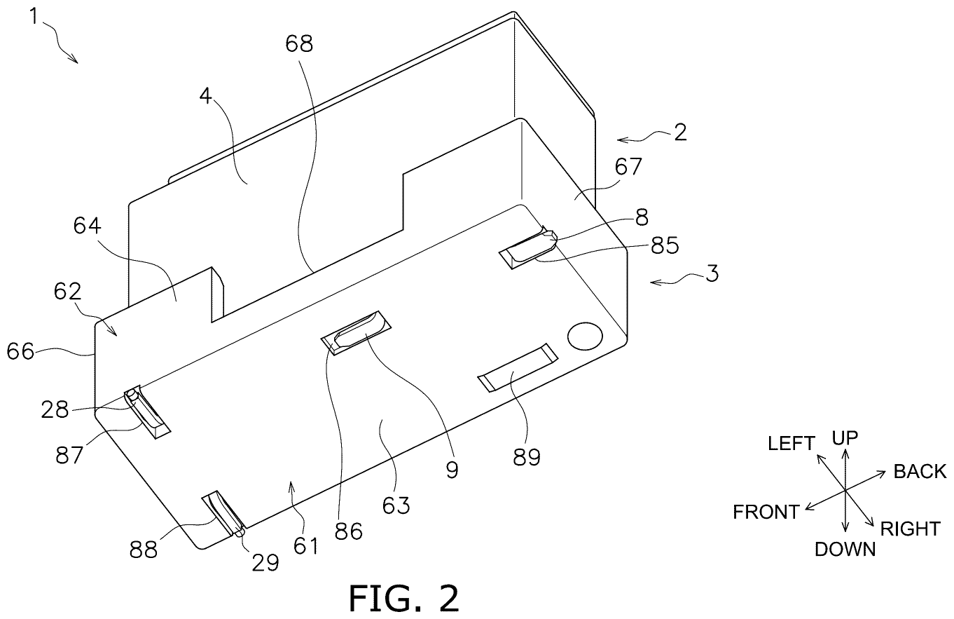

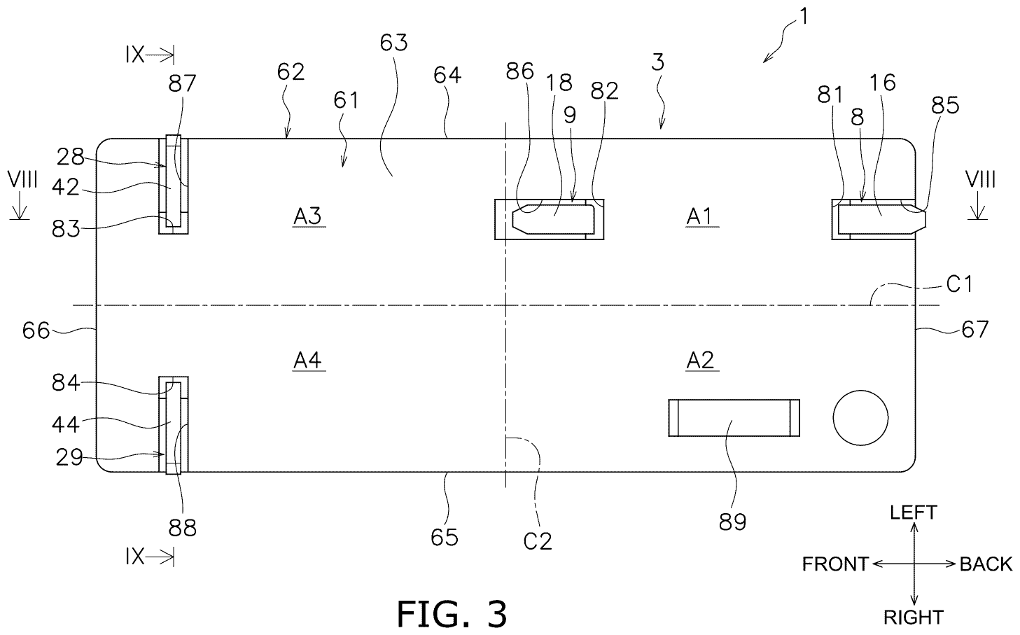

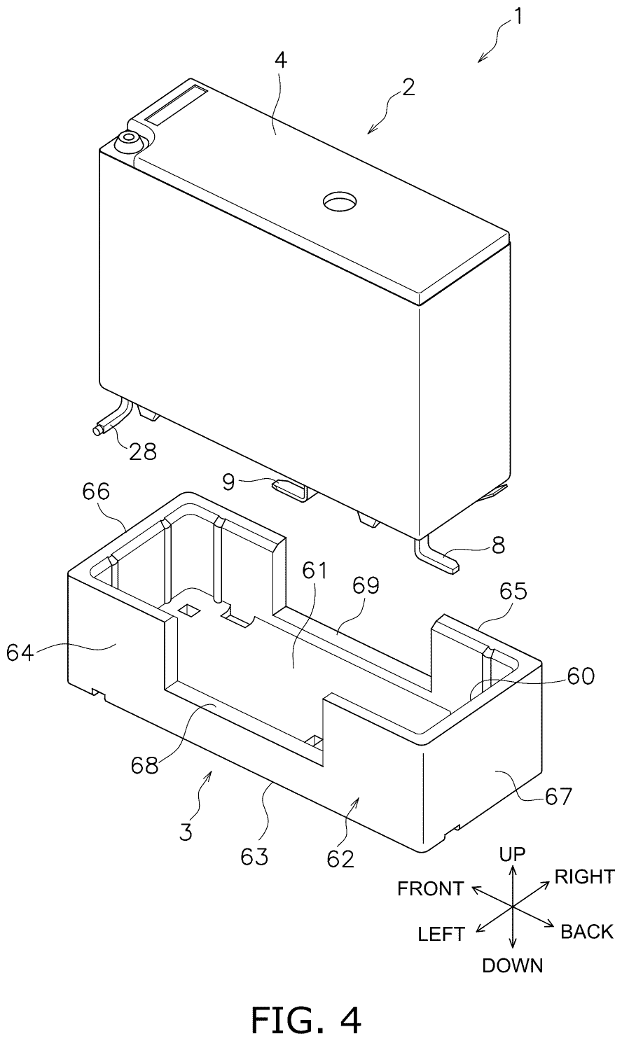

Hereinafter, an embodiment of an electromagnetic relay in accordance with the claimed invention will be described with reference to the drawings. FIGS. 1 and 2 are perspective views of an electromagnetic relay 1. FIG. 3 is a bottom view of the electromagnetic relay 1. FIG. 4 is an exploded perspective view of the electromagnetic relay 1. The electromagnetic relay 1 is a surface-mounted relay. As shown in FIGS. 1 to 4, the electromagnetic relay 1 includes a relay body 2 and a seat 3.

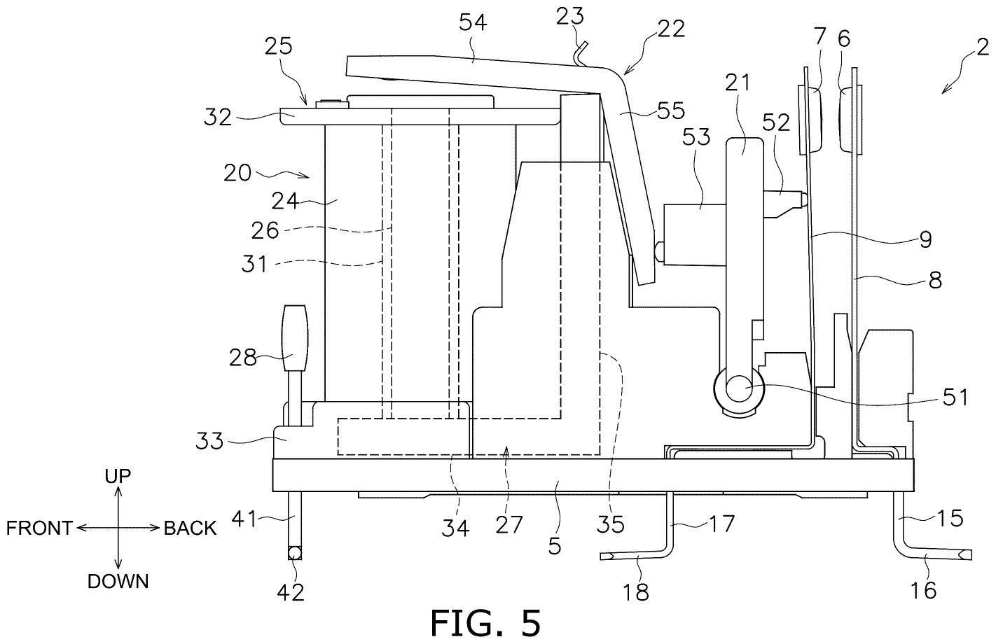

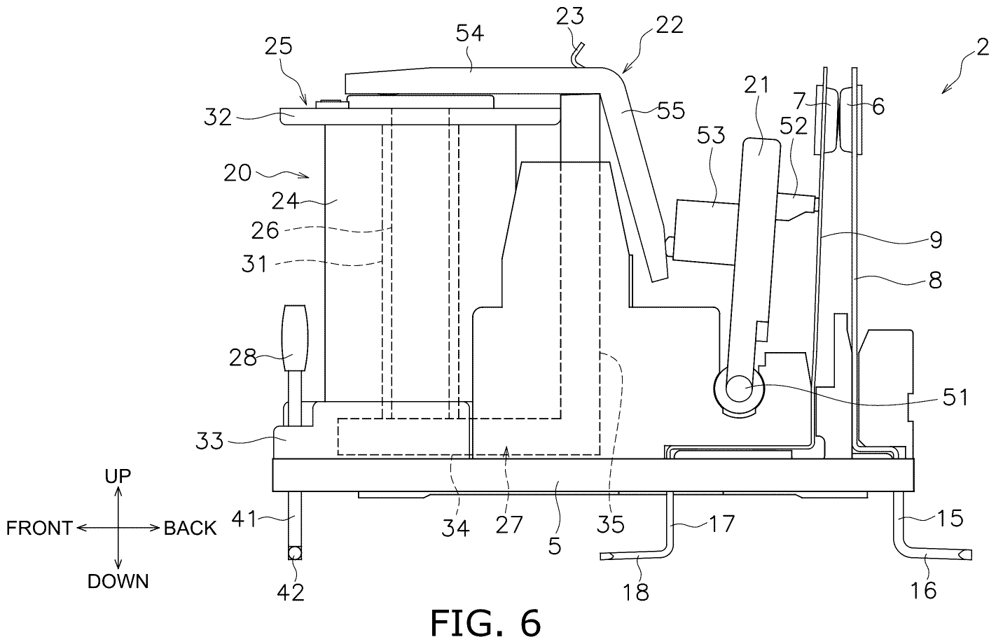

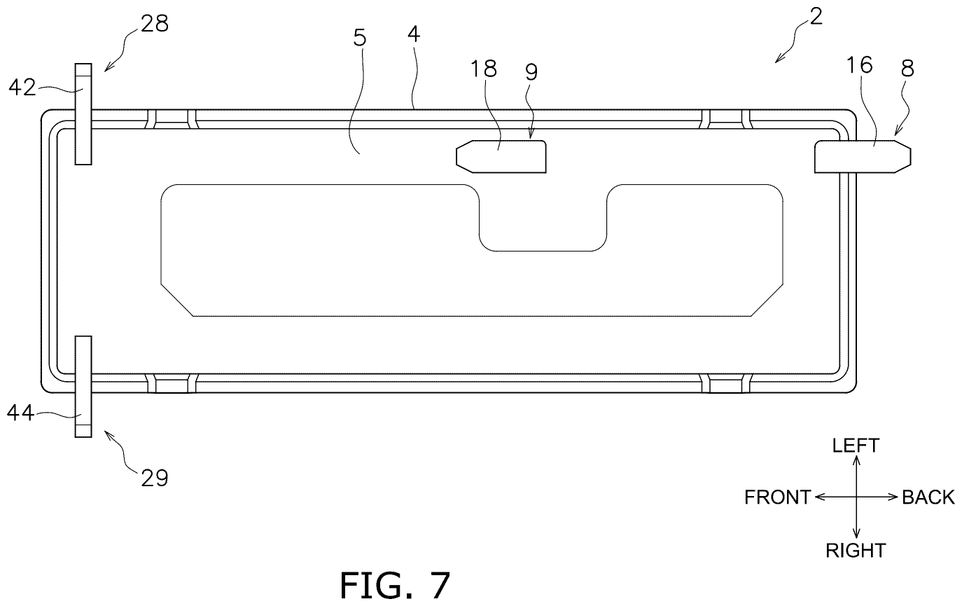

As shown in FIG. 4, the relay body 2 includes a case 4. FIGS. 5 and 6 are side views of the relay body 2 with the case 4 omitted. FIG. 7 is a bottom view of the relay body 2. As shown in FIGS. 5 to 7, the relay body 2 includes a base 5, a fixed contact 6, a movable contact 7, a first contact terminal 8, and a second contact terminal 9.

In the following description, the direction in which the fixed contact 6 and the movable contact 7 are arranged with respect to the base 5 is defined as the upper side, and the opposite direction is defined as the lower side. The direction in which the movable contact 7 is disposed relative to the fixed contact 6 is defined as the front, and the opposite direction is defined as the rear. Additionally, the left and right sides facing forward are defined as the left and right sides, respectively. However, these directions are used for convenience of explanation and do not limit the arrangement of the electromagnetic relay 1.

The fixed contact 6 and the movable contact 7 are made of a conductive metal. The fixed contact 6 and the movable contact 7 are disposed above the base 5. The movable contact 7 is disposed to face the fixed contact 6. The fixed contact 6 is connected to the first contact terminal 8. The movable contact 7 is connected to the second contact terminal 9. The first contact terminal 8 and the second contact terminal 9 are made of a conductive metal. The second contact terminal 9 is disposed to face the first contact terminal 8. The first contact terminal 8 and the second contact terminal 9 are supported by the base 5. The base 5 is made, for example, of resin. The first contact terminal 8 and the second contact terminal 9 extend upward from the base 5. The first contact terminal 8 and the second contact terminal 9 protrude downward from the base 5 to the outside of the relay body 2.

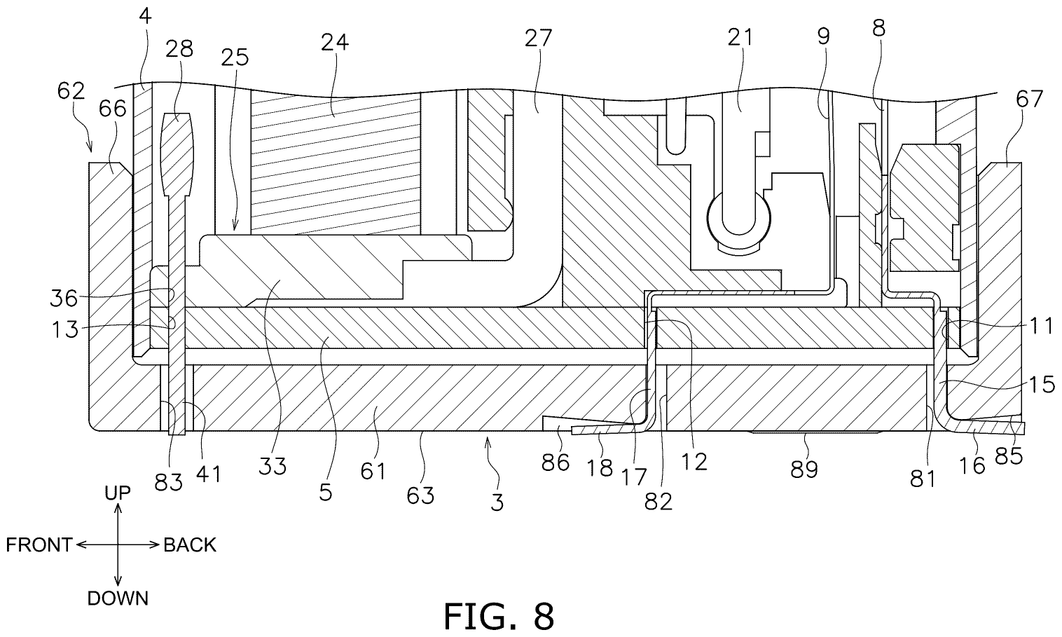

FIG. 8 is a partial cross-sectional view taken along line VIII-VIII in FIG. 3. As shown in FIG. 8, the base 5 includes a first base hole 11 and a second base hole 12. The first contact terminal 8 is press-fitted into the first base hole 11. The first contact terminal 8 protrudes below the base 5 through the first base hole 11. The second contact terminal 9 is press-fitted into the second base hole 12. The second contact terminal 9 protrudes below the base 5 through the second base hole 12.

The first contact terminal 8 includes a first straight portion 15 and a first bent portion 16. The first straight portion 15 extends downward from the base 5 through the first base hole 11. The first bent portion 16 is bent with respect to the first straight portion 15. The first bent portion 16 extends rearward from the first straight portion 15. The second contact terminal 9 includes a second straight portion 17 and a second bent portion 18. The second straight portion 17 extends downward from the base 5 through the second base hole 12. The second bent portion 18 is bent with respect to the second straight portion 17. The second bent portion 18 extends forward from the second straight portion 17.

As shown in FIG. 5, the relay body 2 includes a coil block 20, a card 21, an armature 22, and a return spring 23. The coil block 20 generates an electromagnetic force that moves the movable contact 7 between an open position and a closed position. As shown in FIG. 5, when the movable contact 7 is at the open position, the movable contact 7 is separated from the fixed contact 6. As shown in FIG. 6, when the movable contact 7 is at the closed position, the movable contact 7 is in contact with the fixed contact 6. The coil block 20 includes a coil 24, a spool 25, an iron core 26, a yoke 27, a first coil terminal 28, and a second coil terminal 29.

The coil 24 is wound around the spool 25. Although not shown in the figure, the ends of the coil 24 are connected to the first coil terminal 28 and the second coil terminal 29, respectively. The spool 25 is supported by the base 5. The spool 25 includes a cylindrical portion 31, an upper flange 32, and a lower flange 33. The coil 24 is wound around the cylindrical portion 31. The upper flange 32 and the lower flange 33 protrude radially from the cylindrical portion 31. The upper flange 32 is disposed above the cylindrical portion 31. The lower flange 33 is disposed below the cylindrical portion 31.

The iron core 26 is disposed within the spool 25. The yoke 27 has an L-shaped bent shape. The yoke 27 includes a first yoke portion 34 and a second yoke portion 35. The yoke 27 is bent between the first yoke portion 34 and the second yoke portion 35. The first yoke portion 34 is disposed below the iron core 26. The first yoke portion 34 is connected to the iron core 26. The second yoke portion 35 extends upward from the first yoke portion 34.

The first coil terminal 28 and the second coil terminal 29 are supported by the spool 25 and the base 5. The first coil terminal 28 and the second coil terminal 29 extend upward from the spool 25. The first coil terminal 28 and the second coil terminal 29 protrude downward from the base 5 to the outside of the relay body 2.

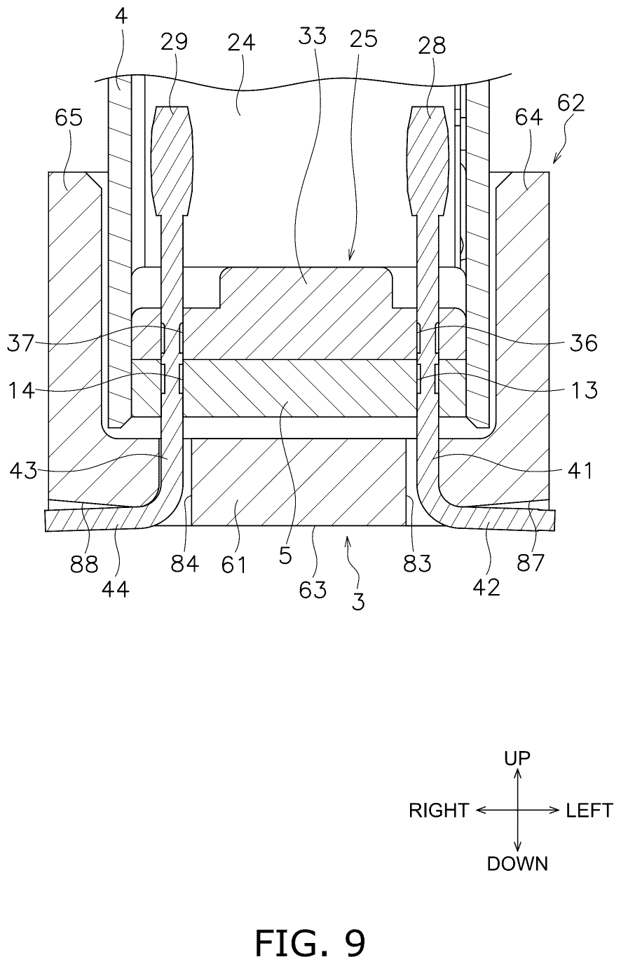

FIG. 9 is a partial cross-sectional view taken along line IX-IX in FIG. 3. As shown in FIG. 9, the spool 25 includes a first spool hole 36 and a second spool hole 37. The first spool hole 36 and the second spool hole 37 are provided in the lower flange 33. The base 5 includes a third base hole 13 and a fourth base hole 14.

The first coil terminal 28 is press-fitted into the first spool hole 36. Alternatively, the first coil terminal 28 may be press-fitted into the third base hole 13. The first coil terminal 28 protrudes below the base 5 through the first spool hole 36 and the third base hole 13. The second coil terminal 29 is press-fitted into the second spool hole 37. Alternatively, the second coil terminal 29 may be press-fitted into the fourth base hole 14. The second coil terminal 29 protrudes below the base 5 through the second spool hole 37 and the fourth base hole 14.

The first coil terminal 28 includes a third straight portion 41 and a third bent portion 42. The third straight portion 41 extends downward from the base 5 through the third base hole 13. The third bent portion 42 is bent with respect to the third straight portion 41. The third bent portion 42 extends leftward from the third straight portion 41. The second coil terminal 29 includes a fourth straight portion 43 and a fourth bent portion 44. The fourth straight portion 43 extends downward from the base 5 through the fourth base hole 14. The fourth bent portion 44 is bent with respect to the fourth straight portion 43. The fourth bent portion 44 extends rightward from the fourth straight portion 43.

As shown in FIG. 5, the card 21 includes a rotation axis 51, a pressing portion 52, and a receiving portion 53. The rotation axis 51 is rotatably supported by the base 5. The pressing portion 52 is disposed to face the second contact terminal 9. The receiving portion 53 is disposed to face the armature 22.

The armature 22 includes a first armature portion 54 and a second armature portion 55. The armature 22 has a bent shape between the first armature portion 54 and the second armature portion 55. The first armature portion 54 is disposed above the iron core 26. The first armature portion 54 is disposed to face the iron core 26. The second armature portion 55 extends downward from the first armature portion 54. The second armature portion 55 is disposed to face the receiving portion 53 of the card 21.

The armature 22 is supported by the second yoke portion 35. The armature 22 is supported rotatably around the upper end of the second yoke portion 35. The return spring 23 is connected to the armature 22. The return spring 23 may be a hinge spring. The return spring 23 biases the armature 22 in a direction in which the second armature portion 55 moves away from the receiving portion 53 of the card 21.

Next, the operation of the relay body 2 will be described. In the following description, the direction in which the movable contact 7 approaches the fixed contact 6 is defined as the closing direction, and the direction in which the movable contact 7 moves away from the fixed contact 6 is defined as the opening direction. When no current flows through the coil 24, the movable contact 7 is separated from the fixed contact 6 as shown in FIG. 5.

When a current flows through the coil 24, the first armature portion 54 is attracted to the iron core 26 by an electromagnetic force generated by the coil 24. As a result, the armature 22 rotates against the biasing force of the return spring 23. When the armature 22 rotates, the second armature portion 55 presses the receiving portion 53 of the card 21 in the closing direction. As a result, the card 21 rotates in the closing direction, causing the pressing portion 52 of the card 21 to press the second contact terminal 9 in the closing direction. The second contact terminal 9 is elastically deformed when pressed by the pressing portion 52, whereby the movable contact 7 moves in the closing direction and contacts the fixed contact 6 as shown in FIG. 6.

When the current to the coil 24 is cut off, the electromagnetic force by which the iron core 26 attracts the first armature portion 54 disappears. Therefore, the armature 22 rotates in the opposite direction to the above-mentioned direction due to the biasing force of the return spring 23. As a result, the card 21 rotates in the opening direction, and the second contact terminal 9 moves in the opening direction due to the elastic force of the second contact terminal 9. As a result, the movable contact 7 moves in the opening direction and separates from the fixed contact 6.

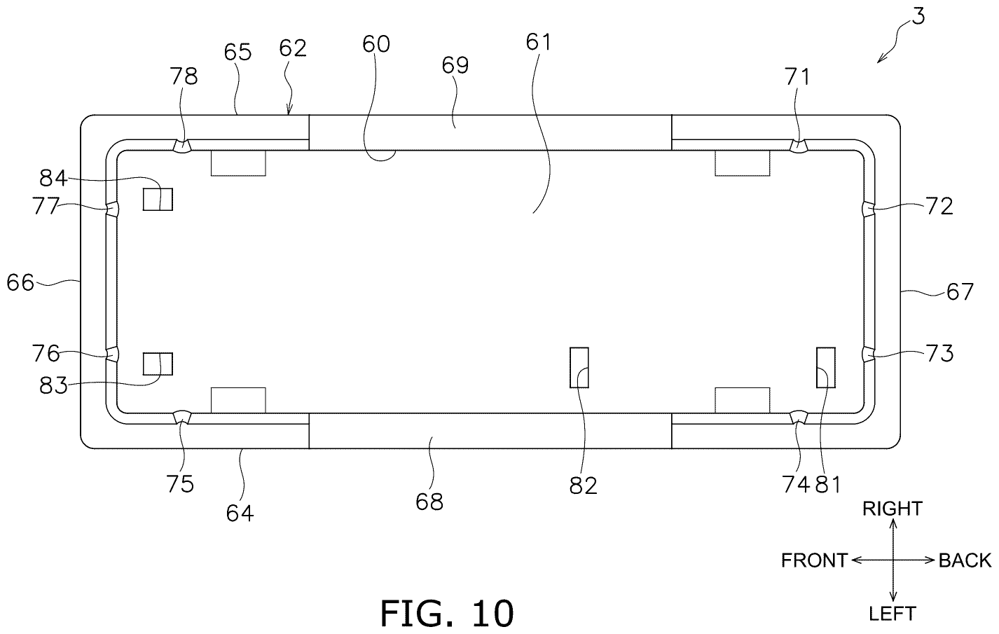

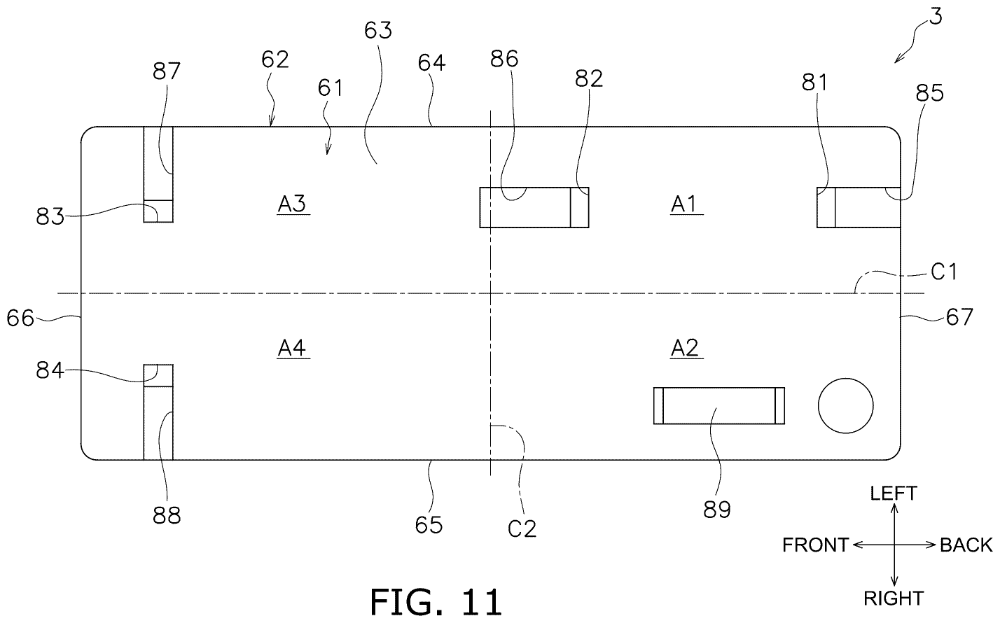

Next, the seat 3 will be described. As shown in FIG. 4, the seat 3 is a separate body from the base 5. The seat 3 is made, for example, of resin. The seat 3 is disposed below the base 5. FIG. 10 is a top view of the seat 3. FIG. 11 is a bottom view of the seat 3. As shown in FIGS. 4 and 10, the seat 3 has a box shape having an opening 60 that opens upward. The relay body 2 is disposed within the opening 60 of the seat 3.

The seat 3 includes a bottom plate 61 and a side wall 62. The bottom plate 61 is disposed below the base 5. The bottom plate 61 includes a bottom surface 63 of the seat 3. The bottom plate 61 supports the base 5. The side wall 62 extends upward from the bottom plate 61. The side wall 62 is disposed to surround the base 5. The upper end of the side wall 62 is located below the upper surface of the case 4. The side wall 62 is disposed so as to surround a portion of the case 4. As shown in FIGS. 8 and 9, the upper end of the side wall 62 is located above the upper surface of the lower flange 33 of the spool 25.

More particularly, the side wall 62 includes a first side wall 64, a second side wall 65, a third side wall 66, and a fourth side wall 67. The first side wall 64 is disposed on the left side of the base 5. The second side wall 65 is disposed on the right side of the base 5. The third side wall 66 is disposed in front of the base 5. The fourth side wall 67 is disposed behind the base 5. The first side wall 64 includes a first recess 68. The first recess 68 is recessed downward from the upper end of the first side wall 64. The second side wall 65 includes a second recess 69. The second recess 69 is recessed downward from the upper end of the second side wall 65.

As shown in FIG. 10, the inner surface of the side wall 62 is provided with a plurality of protrusions 71 to 78. The relay body 2 is fixed to the seat 3 by press-fitting. The plurality of projections 71 to 78 contact the case 4 of the relay body 2. As shown in FIGS. 10 and 11, the seat 3 includes a first seat hole 81, a second seat hole 82, a third seat hole 83, and a fourth seat hole 84. The first to fourth seat holes 81 to 84 extend in the vertical direction in the bottom plate 61 of the seat 3.

As shown in FIG. 11, the seat 3 includes a first groove 85, a second groove 86, a third groove 87, and a fourth groove 88. The first groove 85, the second groove 86, the third groove 87, and the fourth groove 88 are provided on the bottom surface 63 of the seat 3. The first groove 85, the second groove 86, the third groove 87, and the fourth groove 88 are recessed upward from the bottom surface 63 of the seat 3. The first groove 85 extends rearward from the first seat hole 81. The second groove 86 extends forward from the second seat hole 82. The third groove 87 extends leftward from the third seat hole 83. The fourth groove 88 extends rightward from the fourth seat hole 84.

The first seat hole 81 and the first groove 85 are disposed to correspond to the first contact terminal 8. The second seat hole 82 and the second groove 86 are disposed to correspond to the second contact terminal 9. The third seat hole 83 and the third groove 87 are disposed to correspond to the first coil terminal 28. The fourth seat hole 84 and the fourth groove 88 are disposed to correspond to the second coil terminal 29.

As shown in FIG. 8, the first straight portion 15 of the first contact terminal 8 extends downward from the base 5 through the first seat hole 81. The first bent portion 16 of the first contact terminal 8 is bent along the bottom surface 63 of the seat 3. The first bent portion 16 is disposed in the first groove 85. At least a portion of the first bent portion 16 protrudes slightly downward from the first groove 85 below the bottom surface 63. The second straight portion 17 of the second contact terminal 9 extends downward from the base 5 through the second seat hole 82. The second bent portion 18 of the second contact terminal 9 is bent along the bottom surface 63 of the seat 3. The second bent portion 18 is disposed in the second groove 86. At least a portion of the second bent portion 18 protrudes slightly downward from the second groove 86 below the bottom surface 63.

As shown in FIG. 9, the third straight portion 41 of the first coil terminal 28 extends downward from the base 5 through the third seat hole 83. The third bent portion 42 of the first coil terminal 28 is bent along the bottom surface 63 of the seat 3. The third bent portion 42 is disposed in the third groove 87. At least a portion of the third bent portion 42 protrudes slightly downward from the third groove 87 below the bottom surface 63. The fourth straight portion 43 of the second coil terminal 29 extends downward from the base 5 through the fourth seat hole 84. The fourth bent portion 44 of the second coil terminal 29 is bent along the bottom surface 63 of the seat 3. The fourth bent portion 44 is disposed in the fourth groove 88. At least a portion of the fourth bent portion 44 protrudes slightly downward from the fourth groove 88 below the bottom surface 63. The first bent portion 16, the second bent portion 18, the third bent portion 42, and the fourth bent portion 44 are disposed flush with one another.

As shown in FIG. 3, the first bent portion 16 of the first contact terminal 8 and the second bent portion 18 of the second contact terminal 9 are disposed asymmetrically on the bottom surface 63 of the seat 3. More particularly, the first bent portion 16 and the second bent portion 18 are disposed asymmetrically with respect to the center line of the bottom surface 63. The center line of the bottom surface 63 includes a first center line C1 and a second center line C2. The first center line C1 extends in the longitudinal direction of the bottom surface 63. In this embodiment, the longitudinal direction of the bottom surface 63 is the front-rear direction. The second center line C2 is perpendicular to the first center line C1. That is, the second center line C2 extends in the left-right direction.

The first bent portion 16 and the second bent portion 18 are disposed on the bottom surface 63 of the seat 3 on the left side of the first center line C1. The seat 3 includes an auxiliary terminal 89. The auxiliary terminal 89 may be a dummy terminal through which no current flows. The auxiliary terminal 89 is attached to the bottom surface 63 of the seat 3. The auxiliary terminal 89 is made of metal. The auxiliary terminal 89 is disposed flush with the first bent portion 16, the second bent portion 18, the third bent portion 42, and the fourth bent portion 44. The auxiliary terminal 89 is disposed on the opposite side of the first bent portion 16 and the second bent portion 18 with respect to the first center line C1. That is, the auxiliary terminal 89 is disposed on the right side of the first center line C1.

The bottom surface 63 of the seat 3 includes a first area A1, a second area A2, a third area A3, and a fourth area A4. The second area A2 is disposed symmetrically with the first area A1 with respect to the first center line C1. The third area A3 is disposed symmetrically with the first area A1 with respect to the second center line C2. The fourth area A4 is disposed symmetrically with the second area A2 with respect to the second center line C2. The fourth area A4 is disposed symmetrically with the third area A3 with respect to the first center line C1.

The first seat hole 81 and the first groove 85 are disposed in the first area A1. The second seat hole 82 and the second groove 86 are disposed in the first area A1. The third seat hole 83 and the third groove 87 are disposed in the third area A3. The fourth seat hole 84 and the fourth groove 88 are disposed in the fourth area A4.

The first bent portion 16 of the first contact terminal 8 and the second bent portion 18 of the second contact terminal 9 are disposed in the first area A1. The third bent portion 42 of the first coil terminal 28 is disposed in the third area A3. The fourth bent portion 44 of the second coil terminal 29 is disposed in the fourth area A4. The auxiliary terminal 89 is disposed in an area of the first to fourth areas A1 to A4 where the first to fourth bent portions 16, 18, 42, and 44 are not disposed. That is, the auxiliary terminal 89 is disposed in the second area A2.

In the electromagnetic relay 1 described above, the seat 3 prevents the electromagnetic relay 1 from tilting when placed on a circuit board. Therefore, the posture of the electromagnetic relay 1 before soldering can be stably maintained on the circuit board. This allows the electromagnetic relay 1 to be stably mounted on the circuit board.

Although one embodiment of the claimed invention has been described above, the claimed invention is not limited to the above embodiment, and various modifications are possible without departing from the scope of the invention.

The structure of the base 5 is not limited to that in the above embodiment and may be modified. The structures of the fixed contact 6, the movable contact 7, the first contact terminal 8, and the second contact terminal 9 are not limited to those in the above embodiment, and may be modified. For example, the fixed contact 6 may be a separate body from the first contact terminal 8 or may be integrated with the first contact terminal 8. The movable contact 7 may be a separate body from the second contact terminal 9 or may be integrated with the second contact terminal 9. The fixed contact 6 may be connected to the second contact terminal 9. The movable contact 7 may be connected to the first contact terminal 8.

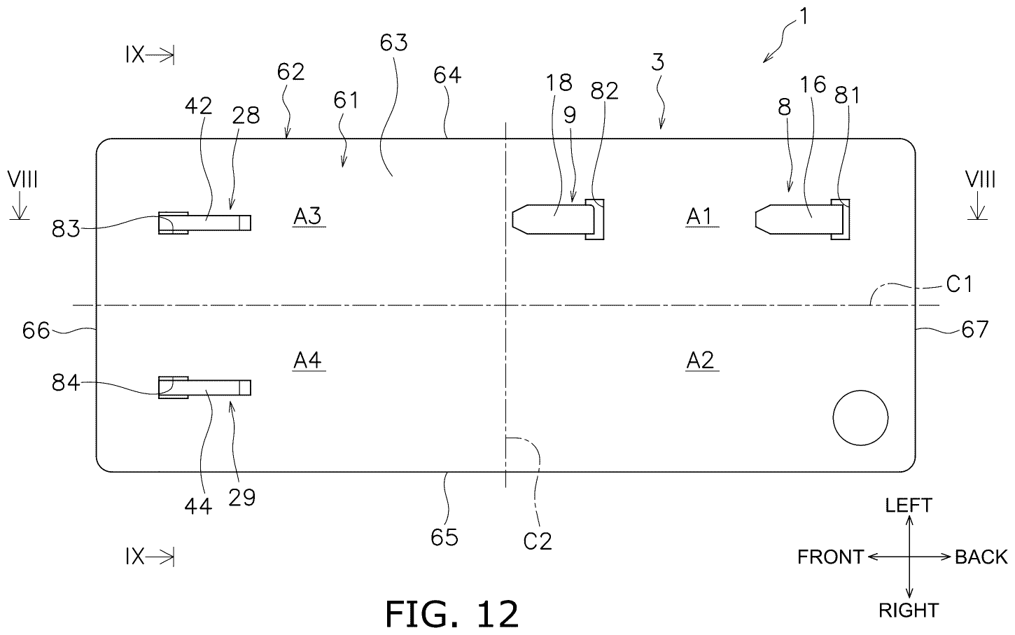

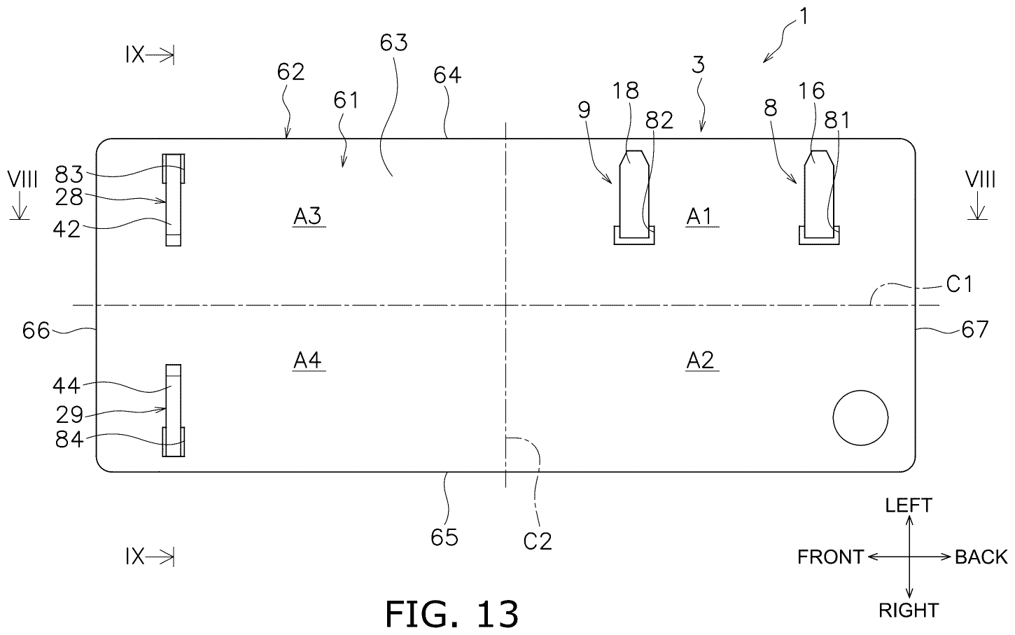

The bending directions of the first to fourth bent portions 16, 18, 42, and 44 are not limited to those in the above embodiment and may be changed. For example, FIG. 12 is a bottom view of the electromagnetic relay 1 of the first modified embodiment. As shown in FIG. 12, the first to fourth bent portions 16, 18, 42, 44 may be bent toward the inside of the bottom surface 63 of the seat 3 so as not to protrude outward from the bottom surface 63 of the seat 3. The first bent portion 16 and the second bent portion 18 may be bent in the same direction. The third bent portion 42 and the fourth bent portion 44 may be bent in the same direction. FIG. 13 is a bottom view of the electromagnetic relay 1 of the second modified embodiment. As shown in FIG. 13, the first bent portion 16 and the second bent portion 18 may be bent not only in the front-rear direction but also in the left-right direction. As shown in FIG. 12, the third bent portion 42 and the fourth bent portion 44 may be bent not only in the left-right direction but also in the front-rear direction. The first bent portion 16 and the second bent portion 18 may be bent in directions facing each other. The third bent portion 42 and the fourth bent portion 44 may be bent in directions facing each other.

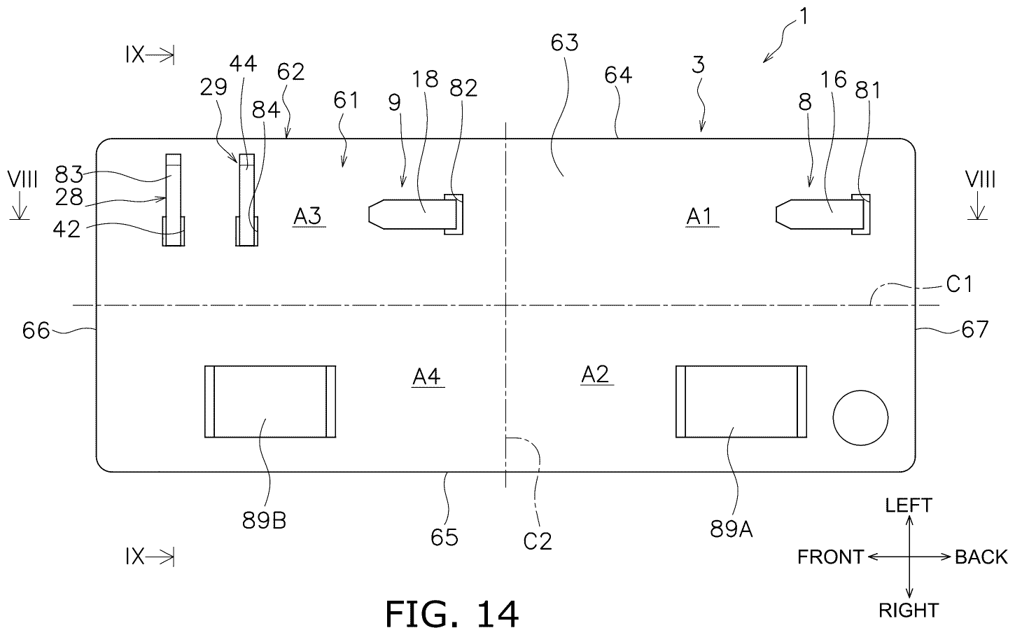

The arrangement of the first to fourth bent portions 16, 18, 42, 44 is not limited to that in the above embodiment and may be changed. For example, FIG. 14 is a bottom view of the electromagnetic relay 1 of the third modified embodiment. As shown in FIG. 14, the first to fourth bent portions 16, 18, 42, and 44 may all be disposed on the same side with respect to the first center line C1.

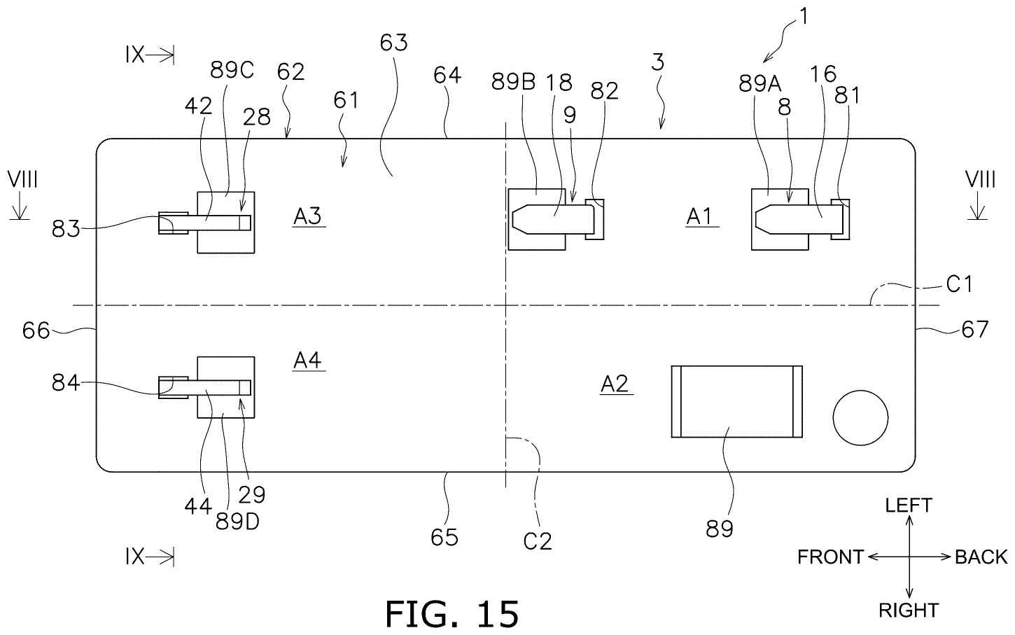

More than one auxiliary terminal may be provided. For example, as shown in FIG. 14, multiple auxiliary terminals 89A and 89B may be disposed on the opposite side to the first to fourth bent portions 16, 18, 42, and 44 with respect to the first center line C1. The auxiliary terminals 89A and 89B shown in FIG. 14 may be dummy terminals through which no current flows. Alternatively, an auxiliary terminal may be provided for at least one of the first to fourth bent portions 16, 18, 42, and 44. For example, FIG. 15 is a bottom view of an electromagnetic relay 1 of a fourth modified embodiment. As shown in FIG. 15, auxiliary terminals 89A to 89D may be provided for the first to fourth bent portions 16, 18, 42, and 44, respectively. In addition, in the electromagnetic relay 1 of the fourth modified embodiment shown in FIG. 15, the auxiliary terminals 89A to 89D may be energized in the same manner as the first contact terminal 8, the second contact terminal 9, the first coil terminal 28, and the second coil terminal 29. Alternatively, the auxiliary terminal may be omitted.

The structures of the coil block 20, the card 21, the armature 22, and the return spring 23 are not limited to those in the above embodiment, and may be modified. For example, the card 21 may be movable linearly.

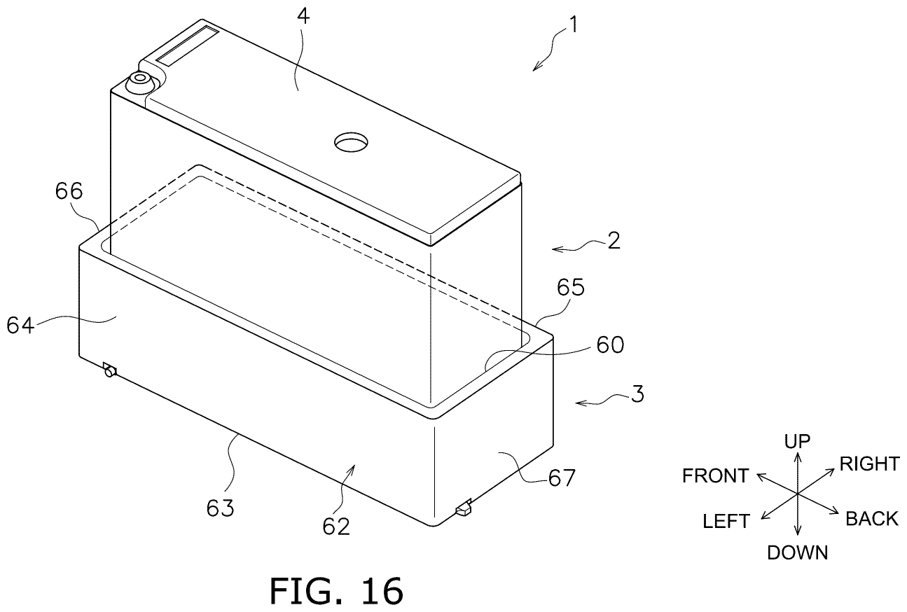

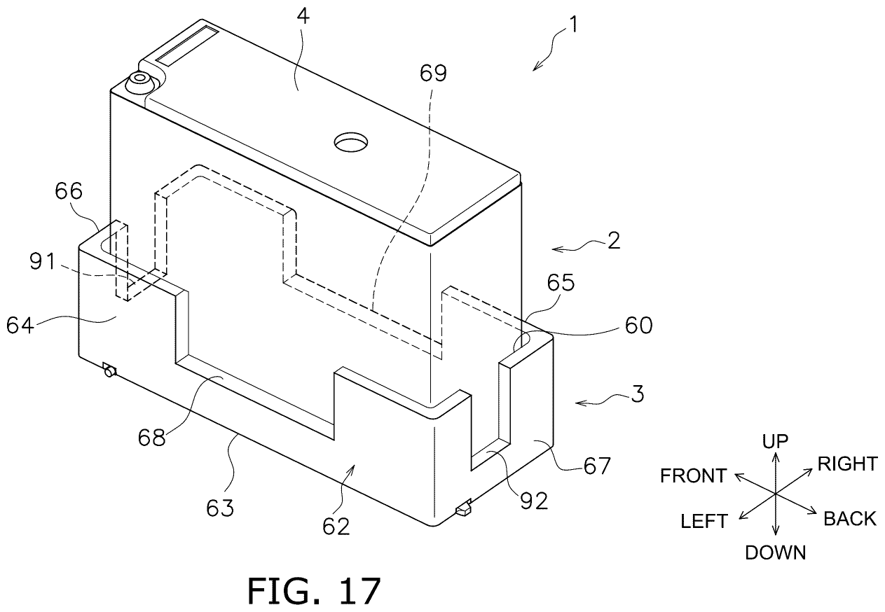

The structure of the seat 3 is not limited to that in the above embodiment and may be modified. The side wall 62 of the seat 3 may be in contact with at least a portion of each of the four side walls of the case 4 on the front, rear, left, and right side. For example, FIG. 16 is a perspective view of an electromagnetic relay 1 of a fifth modified embodiment. As shown in FIG. 16, the first recess 68 and the second recess 69 of the side wall 62 may be omitted. Alternatively, FIG. 17 is a perspective view of an electromagnetic relay 1 of a sixth modified embodiment. As shown in FIG. 17, a third recess 91 and a fourth recess 92 may be provided in the third side wall 66 and the fourth side wall 67, respectively. Alternatively, the side wall 62 may be omitted. The groove may be omitted from the bottom surface 63 of the seat 3. The method of fixing the relay body 2 and the seat 3 is not limited to press-fitting, and may be changed. For example, the relay body 2 and the seat 3 may be fixed to each other by snap fitting.

### REFERENCE SIGNS LIST

3: Seat, 5: Base, 6: Fixed contact, 7: Movable contact, 8: First contact terminal, 9: Second contact terminal, 16: First bent portion, 18: Second bent portion, 28: First coil terminal, 29: Second coil terminal, 42: Third bent portion, 44: Fourth bent portion, 61: Bottom plate, 62: Side wall, 81: First seat hole, 82: Second seat hole, 83: Third seat hole, 84: Fourth seat hole, 85: First groove, 86: Second groove, 87: Third groove, 88: Fourth groove, 89: Auxiliary terminal, A1: First area, A2: Second area, A3: Third area, A4: Fourth area, C1: First center line, C2: Second center line

1. An electromagnetic relay, comprising:
a base;
a seat that is a separate body from the base, the seat being disposed below the base, the seat including a first hole extending in a vertical direction of the electromagnetic relay and a second hole extending in the vertical direction;
a first contact terminal extending downward from the base through the first hole, the first contact terminal including a first bent portion bent along a bottom surface of the seat; and
a second contact terminal extending downward from the base through the second hole, the second contact terminal including a second bent portion bent along the bottom surface of the seat.

2. The electromagnetic relay according to claim 1, wherein the seat includes a first groove provided on the bottom surface of the seat and a second groove provided on the bottom surface of the seat,
the first bent portion being disposed in the first groove and the second bent portion being disposed in the second groove.

3. The electromagnetic relay according to claim 1, wherein the first bent portion and the second bent portion are asymmetrically disposed on the bottom surface of the seat.

4. The electromagnetic relay according to claim 3, wherein the first bent portion and the second bent portion are disposed on a first side of a center line of the bottom surface of the seat.

5. The electromagnetic relay according to claim 1, further comprising a first coil terminal and a second coil terminal,
wherein the seat includes a third hole extending in the vertical direction and a fourth hole extending in the vertical direction,
the first coil terminal extends downward through the third hole and includes a third bent portion bent along the bottom surface of the seat, and
the second coil terminal extends downward through the fourth hole and includes a fourth bent portion bent along the bottom surface of the seat.

6. The electromagnetic relay according to claim 5, wherein the first bent portion, the second bent portion, the third bent portion, and the fourth bent portion are disposed on the bottom surface of the seat on a first side of a center line of the bottom surface of the seat.

7. The electromagnetic relay according to claim 4, further comprising an auxiliary terminal disposed on the bottom surface of the seat on a second side opposite to the first side with respect to the center line of the bottom surface of the seat.

8. The electromagnetic relay according to claim 5,
wherein the bottom surface of the seat includes
a first area,
a second area disposed symmetrically with the first area with respect to a first center line extending in a longitudinal direction of the bottom surface,
a third area disposed symmetrically with the first area with respect to a second center line perpendicular to the first center line, and
a fourth area disposed symmetrically with the second area with respect to the second center line,
the first bent portion is disposed in the first area,
the second bent portion is disposed in the first area or the third area,
the third bent portion is disposed in the third area, and
the fourth bent portion is disposed in the fourth area.

9. The electromagnetic relay according to claim 8, further comprising at least one auxiliary terminal disposed on the bottom surface of the seat in one of the first area to the fourth area where the first bent portion to the fourth bent portion are not disposed.

10. The electromagnetic relay according to claim 5, further comprising an auxiliary terminal provided on at least one of the first bent portion, the second bent portion, the third bent portion, and the fourth bent portion.

11. The electromagnetic relay according to claim 5, wherein
the seat includes a third groove provided on the bottom surface of the seat and a fourth groove provided on the bottom surface of the seat,
the third bent portion is disposed in the third groove, and
the fourth bent portion is disposed in the fourth groove.

12. The electromagnetic relay according to claim 1, wherein the seat includes a bottom plate including the bottom surface and a side wall extending upward from the bottom plate and surrounding the base.

13. The electromagnetic relay according to claim 12, wherein the side wall includes a recess that is recessed downward.

14. The electromagnetic relay according to claim 12, wherein the side wall includes a first side wall disposed on a left side of the base, a second side wall disposed on a right side of the base, a third side wall disposed in front of the base, and a fourth side wall disposed behind the base.

15. An electromagnetic relay, comprising:
a base;
a seat that is a separate body from the base, the seat being disposed below the base, the seat including a third hole extending in a vertical direction of the electromagnetic relay and a fourth hole extending in the vertical direction;
a first coil terminal extending downward from the base through the third hole, the first coil terminal including a third bent portion bent along a bottom surface of the seat; and
a second coil terminal extending downward from the base through the fourth hole, the second coil terminal including a fourth bent portion bent along the bottom surface of the seat.
